(19) United States
(12) Patent Application Publication
(10) Pub. No.: US 2026/0109792 A1
(43) Pub. Date: Apr. 23, 2026

(54) STORAGE STABLE METALLOCENE SOLUTIONS AND USES THEREOF IN CATALYST SYSTEMS FOR ETHYLENE POLYMERIZATION

(71) Applicant: Chevron Phillips Chemical Company LP, The Woodlands, TX (US)

(72) Inventors: Jeremy M. Praetorius, Bartlesville, OK (US); Zhou Chen, Bartlesville, OK (US); Elizabeth Winton, Bartlesville, OK (US); Casey Sheline, Bartlesville, OK (US)

(21) Appl. No.: 18/923,808

(22) Filed: Oct. 23, 2024

(51) Int. Cl. C08F 10/02

(52) U.S. Cl. CPC C08F 10/02

(57) ABSTRACT

Metallocene solutions containing trimethylaluminum, a C₄-C₈ alkane solvent, and a metallocene compound in an amount from 0.2 to 8 mg per mL of the metallocene solution are described. Catalyst compositions incorporating these metallocene solutions plus an activator-support and an organoaluminum compound can be utilized in polymerization processes to produce polyethylene products.

### FIELD OF THE INVENTION

The present disclosure concerns toluene-free metallocene solutions, catalyst compositions containing these metallocene solutions, and the use of the catalyst compositions in polymerization processes to produce ethylene-based polymers.

### BACKGROUND OF THE INVENTION

Toluene is often present in metallocene solutions and catalyst compositions because it is generally a very good solvent for metallocene compounds. However, the utilization of toluene raises FDA compliance concerns for ethylene polymers produced from catalyst compositions in which toluene is present, such as in food contact applications. It would be beneficial to have metallocene solutions and resulting catalyst compositions that do not contain toluene, but that perform comparably to those that do contain toluene. Accordingly, it is to this end that the present disclosure is generally directed.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

The present invention generally relates to metallocene solutions and to catalyst compositions that contain these solutions, as well as their use in polymerization processes. In particular, aspects of the present invention are directed to metallocene solutions that are free of toluene. Catalyst compositions containing the toluene-free metallocene solutions can be used in polymerization processes to produce polyethylene products that have the same properties as those produced with catalyst compositions containing metallocene solutions with a toluene solvent.

In one aspect of this invention, metallocene solutions are disclosed, and in this aspect, the metallocene solution can comprise (a) trimethylaluminum (TMA), (b) a C₄-C₈ alkane solvent, and (c) a metallocene compound in an amount from 0.2 to 8 mg per mL of the metallocene solution.

In another aspect of this invention, catalyst compositions are disclosed, and in this aspect, the catalyst composition can comprise (i) a metallocene solution comprising trimethylaluminum (TMA), a C₄-C₈ alkane solvent, and a metallocene compound in an amount from 0.2 to 8 mg per mL of the metallocene solution, (ii) an activator-support, and (iii) an organoaluminum compound.

In yet another aspect of this invention, polymerization processes are disclosed, and in this aspect, the polymerization processes can comprise contacting the catalyst composition (i.e., any catalyst composition disclosed herein) with ethylene and an optional olefin comonomer in a polymerization reactor system under polymerization conditions to produce an ethylene polymer.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the compositions and processes described herein are contemplated with or without explicit description of the particular combination. Additionally, unless explicitly recited otherwise, any aspect and/or feature disclosed herein can be combined to describe inventive features consistent with the present disclosure.

In this disclosure, while compositions and processes are often described in terms of “comprising” various components or steps, the compositions and processes also can “consist essentially of” or “consist of” the various components or steps, unless stated otherwise.

The terms “a,” “an,” and “the” are intended to include plural alternatives, e.g., at least one. For instance, the disclosure of “a polymerization reactor” or “a metallocene compound” is meant to encompass one, or combinations of more than one, polymerization reactor or metallocene compound, unless otherwise specified.

For any particular compound or group disclosed herein, any name or structure (general or specific) presented is intended to encompass all conformational isomers, regioisomers, stereoisomers, and mixtures thereof that can arise from a particular set of substituents, unless otherwise specified. The name or structure (general or specific) also encompasses all enantiomers, diastereomers, and other optical isomers (if there are any) whether in enantiomeric or racemic forms, as well as mixtures of stereoisomers, as would be recognized by a skilled artisan, unless otherwise specified. For instance, a general reference to pentane includes n-pentane, 2-methyl-butane, and 2,2-dimethylpropane; and a general reference to a butyl group includes a n-butyl group, a sec-butyl group, an iso-butyl group, and a t-butyl group.

The term “hydrocarbon” whenever used in this specification and claims refers to a compound containing only carbon and hydrogen. The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

The term “polymer” is used herein generically to include olefin homopolymers, copolymers, terpolymers, and the like, as well as alloys and blends thereof. The term “polymer” also includes impact, block, graft, random, and alternating copolymers. A copolymer can be derived from an olefin monomer and one olefin comonomer, while a terpolymer can be derived from an olefin monomer and two olefin comonomers. Accordingly, “polymer” encompasses copolymers and terpolymers. Similarly, the scope of the term “polymerization” includes homopolymerization, copolymerization, and terpolymerization. Therefore, an ethylene polymer would include ethylene homopolymers, ethylene copolymers (e.g., ethylene/α-olefin copolymers), ethylene terpolymers, and the like, as well as blends or mixtures thereof. Thus, an ethylene polymer encompasses polymers often referred to in the art as LLDPE (linear low density polyethylene) and HDPE (high density polyethylene). As an example, an ethylene copolymer can be derived from ethylene and a comonomer, such as 1-butene, 1-hexene, or 1-octene. If the monomer and comonomer were ethylene and 1-hexene, respectively, the resulting polymer can be categorized an as ethylene/1-hexene copolymer. The term “polymer” also includes all possible geometrical configurations, if present and unless stated otherwise, and such configurations can include isotactic, syndiotactic, and random symmetries. The term “polymer” also is meant to include all molecular weight polymers.

The term “metallocene solution” does not depend upon the actual product or composition resulting from the contact or reaction of the initial components of the disclosed or claimed metallocene solution, the nature of the active catalytic site, or the fate of the C₄-C₈ alkane solvent(s), the trimethylaluminum (TMA) compound, or the metallocene compound(s), after combining these components. Therefore, the term “metallocene solution” can encompass the initial starting components of the metallocene solution, as well as whatever product(s) may result from contacting these initial starting components. According to this description, it is possible for the components of the metallocene solution, once contacted, to have reacted to form at least one chemical compound, formulation, species, or structure different from the distinct compounds or components used to initially prepare the metallocene solution. For instance, a metallocene compound originally in the dichloride form may exist in the dimethyl form once dissolved into the metallocene solution.

The terms “catalyst composition,” “catalyst mixture,” “catalyst system,” and the like, do not depend upon the actual product or composition resulting from the contact or reaction of the initial components of the disclosed or claimed catalyst composition/mixture/system, the nature of the active catalytic site, or the fate of the metallocene compound(s) or solution, the organoaluminum compound(s), or the activator-support(s), after combining these components. Therefore, the terms “catalyst composition,” “catalyst mixture,” “catalyst system,” and the like, can encompass the initial starting components of the composition, as well as whatever product(s) may result from contacting these initial starting components, and this is inclusive of both heterogeneous and homogenous catalyst systems or compositions.

Various numerical ranges are disclosed herein. When a range of any type is disclosed or claimed, the intent is to disclose or claim individually each possible number that such a range could reasonably encompass, including end points of the range as well as any sub-ranges and combinations of sub-ranges encompassed therein, unless otherwise specified. As a representative example, the present disclosure recites that the weight ratio of the metallocene compound to the activator-support in a catalyst composition can be in certain ranges. By a disclosure that the weight ratio can be in a range from 1:1 to 1:100,000, the intent is to recite that the weight ratio can be any ratio in the range and, for example, can include any range or combination of ranges from 1:1 to 1:100,000, such as from 1:10 to 1:10,000, from 1:1 to 1:1000, from 1:10 to 1:200, or from 1:10 to 1:50, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

Disclosed herein are metallocene solutions containing trimethylaluminum (TMA), a C₄-C₈ alkane solvent, and a metallocene compound in an amount from 0.2 to 8 mg per mL of the metallocene solution. Catalyst compositions containing any of the metallocene solutions disclosed herein, an activator-support, and an organoaluminum compound, as well as polymerization processes utilizing these catalyst compositions, also are disclosed.

Toluene is commonly utilized in metallocene solutions and catalyst compositions as a solvent for the metallocene compound(s). However, FDA regulations, particularly for food contact applications, often limit the amount of residual toluene that can be present in ethylene polymers produced from catalyst compositions in which toluene is present.

Therefore, one objective of this invention is to produce metallocene solutions and subsequent catalyst compositions that are toluene-free, but that still have excellent solubility of the metallocene compound.

Another objective is to produce toluene-free metallocene solutions with improved long-term storage stability, such that after storage for several days (or for a week, for 2 weeks, for a month, or for several months), catalyst compositions containing the metallocene solution have the same catalytic activity regardless of the age of the metallocene solution. This is particularly beneficial, since metallocene solutions can be prepared in large quantities, and shipped and transported, and stored for days and weeks without a loss in catalytic activity.

Yet another objective is to utilize the catalyst compositions containing the toluene-free metallocene solutions of the present invention in polymerization processes to produce polyethylene products that have the same properties as those produced with catalyst compositions containing toluene-based metallocene solutions.

### Metallocene Solutions

Metallocene solutions of the present invention can comprise (or consist essentially of, or consist of) trimethylaluminum (TMA), a C₄-C₈ alkane solvent, and a metallocene compound in an amount from 0.2 to 8 mg per mL of the metallocene solution. Unexpectedly, very good solubility of the metallocene compound resulted from the use of the alkane solvent in combination with TMA. Generally, the features of any of these solutions (e.g., the C₄-C₈ alkane solvent, the metallocene compound, the relative amounts of the respective components, the presence or absence of additional components, among others) are independently described herein, and these features can be combined in any combination to further describe the disclosed metallocene solutions.

In accordance with aspects of this invention, the C₄-C₈ alkane solvent utilized in the metallocene solution can be any suitable C₄-C₈ alkane. For instance, the C₄-C₈ alkane solvent can comprise a linear C₄-C₈ alkane compound, a branched C₄-C₈ alkane compound, a cyclic C₄-C₈ alkane compound, or a combination thereof. The C₄-C₈ alkane solvent can comprise a mixture of two or more C₄-C₈ alkanes, such as two or more C₄-C₈ alkane compounds in any relative proportions. The C₄-C₈ alkane solvent can comprise butane (e.g., n-butane or iso-butane), pentane (e.g., n-pentane, neopentane, cyclopentane, or isopentane), hexane (e.g., hexane or cyclohexane), heptane (e.g., n-heptane or cycloheptane), octane (e.g., n-octane or iso-octane), or any combination thereof. In a particular aspect, the C₄-C₈ alkane solvent comprises n-heptane.

The metallocene compound utilized in the metallocene solution can be any suitable bridged metallocene compound or any bridged metallocene compound disclosed herein and/or any suitable unbridged metallocene compound or any unbridged metallocene compound disclosed herein. Metallocene solutions consistent with aspects this invention can comprise two or more metallocene compounds, for example, two or more bridged metallocene compounds, two or more unbridged metallocene compounds, or at least one bridged metallocene compound and at least one unbridged metallocene compound. The metallocene compound can comprise, for example, a transition metal from Groups IIIB-VIIIB of the Periodic Table of the Elements. The metallocene compound can comprise a Group III, IV, V, or VI transition metal, for instance, the metallocene compound can comprise chromium, titanium, zirconium, hafnium, or vanadium.

In some aspects of this invention, the metallocene compound can comprise a bridged metallocene compound, e.g., zirconium or hafnium, such as a bridged zirconium or hafnium based metallocene compound with a fluorenyl group, or a bridged zirconium or hafnium based metallocene compound with a cyclopentadienyl group and a fluorenyl group. Such bridged metallocenes, in some aspects, can contain an aryl group and/or an alkenyl group (e.g., a terminal alkenyl group) on the bridging group. For example, in one aspect, the metallocene compound comprises a bridged zirconium or hafnium based metallocene compound with a fluorenyl group, and an aryl group and/or an alkenyl group on the bridging group. In another aspect, the metallocene compound comprises a bridged zirconium or hafnium based metallocene compound with a cyclopentadienyl group and a fluorenyl group, and an aryl group and/or an alkenyl group on the bridging group. For instance, the metallocene compound can comprise a bridged zirconium or hafnium based metallocene compound with a fluorenyl group, and an aryl group on the bridging group; alternatively, a bridged zirconium or hafnium based metallocene compound with a cyclopentadienyl group and fluorenyl group, and an aryl group on the bridging group; alternatively, a bridged zirconium based metallocene compound with a fluorenyl group, and an aryl group on the bridging group; alternatively, a bridged hafnium based metallocene compound with a fluorenyl group, and an aryl group on the bridging group. For instance, the metallocene compound can comprise a bridged zirconium or hafnium based metallocene compound with a fluorenyl group, and aryl groups on the bridging group; alternatively, a bridged zirconium or hafnium based metallocene compound with a cyclopentadienyl group and fluorenyl group, and aryl groups on the bridging group; alternatively, a bridged zirconium based metallocene compound with a fluorenyl group, cyclopentadienyl group, an aryl group on the bridging group and an alkenyl group (e.g., a terminal alkenyl group) on the cyclopentadienyl group. The metallocene compound can also comprise a bridged zirconium or hafnium based metallocene compound with a fluorenyl group, and an alkenyl group on the bridging group; alternatively, a bridged zirconium or hafnium based metallocene compound with a cyclopentadienyl group and fluorenyl group, and an alkenyl group on the bridging group; alternatively, a bridged zirconium based metallocene compound with a fluorenyl group, and an alkenyl group on the bridging group; alternatively, a bridged hafnium based metallocene compound with a fluorenyl group, and an alkenyl group on the bridging group. In these and other aspects, the aryl group can be a phenyl group and the alkenyl group can be a terminal alkenyl group. In an aspect, the fluorenyl group can be unsubstituted or the fluorenyl group can be an alkyl substituted fluorenyl group (e.g., with one or more alkyl substituents). Additionally or alternatively, the cyclopentadienyl group can be unsubstituted or the cyclopentadienyl group can be an alkenyl-substituted cyclopentadienyl group (e.g., with one or more alkenyl substituents).

Illustrative and non-limiting examples of bridged metallocene compounds (e.g., with zirconium or hafnium) that can be employed in metallocene solutions and catalyst systems consistent with aspects of the present invention are described in U.S. Pat. Nos. 7,026,494, 7,041,617, 7,226,886, 7,312,283, 7,517,939, 7,619,047, 8,637,616, 8,431,729, and 11,325,995.

In accordance with aspects of this invention, the metallocene compound comprises an unbridged zirconium based metallocene compound containing a cyclopentadienyl group and an indenyl group. In an aspect, the cyclopentadienyl group can be unsubstituted or the cyclopentadienyl group can be an alkyl-substituted cyclopentadienyl group (e.g., with one or more alkyl substituents). In another aspect, the indenyl group can be unsubstituted or the indenyl group can be an alkenyl-substituted indenyl group (e.g., with one or more alkenyl substituents).

Illustrative and non-limiting examples of unbridged metallocene compounds (e.g., with zirconium or hafnium) that can be employed in metallocene solutions and catalyst systems consistent with aspects of the present invention are described in U.S. Pat. Nos. 7,199,073, 7,226,886, 7,312,283, 7,619,047, and 11,186,665.

According to aspects of the present invention, the metallocene solution can contain, either singly or in any combination, (η⁵-1-butylcyclopentadenyl)(η⁵-1-propen-2-yl-indenyl) zirconium dichloride, diphenylmethylidene(η⁵-(3-penten-4-yl)cyclopentadiene-1-yl)(η⁵-2,7-di-tert-butylfluoren-9-ylidene) hafnium dichloride, methyl(buten-3-yl)methylidene(η⁵-cyclopentadienyl)(η⁵-2,7-di-tert-butylfluoren-9-ylidene) zirconium dichloride, rac-1,2-ethylenebis(η⁵-1-indenyl) zirconium dichloride, rac-dimethylsilylbis(η⁵-1-indenyl) zirconium dichloride, diphenylmethylidene(η⁵-(3-penten-4-yl)cyclopentadiene-1-yl)(η⁵-2,7-di-tert-butylfluoren-9-ylidene) zirconium dichloride, diethylmethylidene(η⁵-cyclopentadienyl)(η⁵-3-n-propylinden-1-yl) zirconium dichloride, bis(η⁵-indenyl) zirconium dichloride, and/or bis(η⁵-n-butylcyclopentadienyl) zirconium dichloride.

The metallocene compound is present in the metallocene solution of the present invention in an amount from 0.2 to 8 mg of the metallocene compound per milliliter of the metallocene solution. Other suitable amounts of the metallocene compound in the metallocene solution, based on the volume of the metallocene solution, include from 0.2 to 5 mg/mL, from 0.5 to 8 mg/mL from 0.5 to 5 mg/mL from 0.5 to 3 mg/mL, from 0.5 to 2.5 mg/mL, from 0.75 to 8 mg/mL, from 0.75 to 3 mg/mL, from 0.75 to 2.25 mg/mL, from 1 to 3 mg/mL, or from 1 to 2.5 mg/mL. These mg/mL values are determined at standard temperature and pressure (25° C. and 1 atm). Additionally or alternatively, the metallocene solution can contain any suitable weight percentage of the metallocene compound, and representative ranges include from 0.02 to 1 wt. %, from 0.02 to 0.7 wt. %, from 0.02 to 0.5 wt. %, from 0.05 to 1 wt. %, from 0.05 to 0.7 wt. %, from 0.05 to 0.5 wt. %, from 0.1 to 1 wt. %, from 0.1 to 0.7 wt. %, or from 0.1 to 0.4 wt. % of the metallocene compound, based on the total weight of the metallocene solution.

Additionally or alternatively, the molar ratio of aluminum of the trimethylaluminum (TMA) to the transition metal of the metallocene compound can be in any suitable range, and representative ranges include from 0.5:1 to 100:1, from 0.5:1 to 25:1, from 1:1 to 75:1, from 1:1 to 15:1, from 1:1 to 10:1, from 2:1 to 50:1, from 2:1 to 15:1, from 2:1 to 10:1, or from 2:1 to 5:1.

While the metallocene solutions can contain TMA, the C₄-C₈ alkane solvent, and the metallocene compound, the vast majority of the metallocene solution is the alkane solvent, generally above 90 wt. %. More often, the alkane solvent represents at least 92 wt. % of the metallocene solution in one aspect, at least 95 wt. % in another aspect, at least 97 wt. % in another aspect, at least 98 wt. % in yet another aspect, and at least 99 wt. % of the metallocene solution in still another aspect.

Advantageously, the metallocene solutions of the present invention are stable at room temperature (25° C., inert atmosphere, no exposure to light) for any suitable time period, for example, at least 3 days, at least 5 days, at least 7 days, at least 9 days, at least 14 days, at least 20 days, at least 25 days, or at least 28 days. Given the long duration of the storage stability test, the upper limit of storage stability (in days) is generally not determined. Thus, these are minimum threshold values, since generally the maximum value is not determined, so long as the minimum threshold value is exceeded. Herein, “stable” is meant to indicate that there is not a significant loss of catalyst activity, and is quantified by the either the (Ametallocene activity) or the (Aactivator-support activity), or both, after storage for the respective time period, being greater than or within 20% of an initial catalyst activity. In other words, the percentage change in the activity of the catalyst system containing the metallocene solution from an initial catalyst activity to a catalyst activity after storage for the respective time period—measured by at least one of the (Ametallocene activity) and/or the (Aactivator-support activity)—is greater than or within 20% of the initial catalyst activity. The storage stability of the metallocene solutions is demonstrated in the examples that follow. For instance, the initial catalyst activity can be measured after preparation of the metallocene solution (and catalyst composition), but often is measured after 1 day. Accordingly, after 8 days (a storage period of 7 days), if the (Ametallocene activity) and/or the (Aactivator-support activity) is/are greater than or within 20% of the catalyst activity at 1 day (i.e., retaining at least 80% of the initial catalytic activity), then the metallocene solution is considered stable for a time period of 7 days.

### Catalyst Compositions

Aspects of this invention also are directed to catalyst compositions that comprise (or consist essentially of, or consist of) any of the metallocene solutions disclosed herein as well as an activator-support and an organoaluminum compound. Generally, the features of any of these compositions (e.g., the features and attributes of the metallocene solutions, the features and attributes of the activator-support, the organoaluminum compound, the relative amounts of the respective components, the presence or absence of additional components, among others) are independently described herein, and these features can be combined in any combination to further describe the disclosed catalyst compositions.

In addition to the metallocene solution, the catalyst compositions of the present invention can contain any suitable activator-support. In one aspect, the activator-support can comprise a solid oxide treated with an electron-withdrawing anion, for example, comprising any suitable solid oxide treated with any suitable electron-withdrawing anion. Non-limiting examples of suitable activator-supports are disclosed in, for instance, U.S. Pat. Nos. 7,294,599, 7,601,665, 7,884,163, 8,309,485, 8,623,973, 8,703,886, and 11,912,809.

The solid oxide can encompass oxide materials such as alumina, “mixed oxides” thereof such as silica-alumina, coatings of one oxide on another, and combinations and mixtures thereof. The mixed oxides such as silica-alumina can be single or multiple chemical phases with more than one metal combined with oxygen to form the solid oxide. Examples of mixed oxides that can be used to form an activator-support, either singly or in combination, can include, but are not limited to, silica-alumina, silica-titania, silica-zirconia, alumina-titania, alumina-zirconia, zinc-aluminate, alumina-boria, silica-boria, aluminophosphate-silica, titania-zirconia, and the like. The solid oxide used herein also can encompass oxide materials such as silica-coated alumina, as described in U.S. Pat. Nos. 7,884,163 and 11,912,809.

The solid oxide can be any suitable solid oxide, non-limiting examples of which can include silica, alumina, silica-alumina, silica-coated alumina, aluminum phosphate, aluminophosphate, heteropolytungstate, titania, zirconia, magnesia, boria, zinc oxide, a mixed oxide thereof, or any mixture thereof. The silica-alumina or silica-coated alumina solid oxide materials which can be used can have a silica content from 5% by weight to 95% by weight. In one aspect, the silica content of these solid oxides can be from 10% by weight to 80% silica by weight, or from 20% by weight to 70% silica by weight. In another aspect, such materials can have silica contents ranging from 15% to 60% silica by weight, or from 25% to 50% silica by weight. The solid oxides contemplated herein can have any suitable surface area, pore volume, and particle size, as would be recognized by those of skill in the art.

The electron-withdrawing component used to treat the solid oxide can be any component that increases the Lewis or Bronsted acidity of the solid oxide upon treatment (as compared to the solid oxide that is not treated with at least one electron-withdrawing anion). Generally, the electron-withdrawing component can be an electron-withdrawing anion derived from a salt, an acid, or other compound, such as a volatile organic compound, that serves as a source or precursor for that anion. Examples of electron-withdrawing anions consistent with aspects of the present invention can include, but are not limited to, sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, tungstate, molybdate, or any combination thereof. In addition, other ionic or non-ionic compounds that serve as sources for these electron-withdrawing anions also can be employed.

The activator-support generally can contain from 1 wt. % to 30 wt. % of the electron-withdrawing anion, based on the weight of the activator-support. In particular aspects provided herein, the activator-support can contain from 2 to 20 wt. %, from 2 to 15 wt. %, from 2 to 10 wt. %, or from 3 to 10 wt. %, of the electron-withdrawing anion, based on the total weight of the activator-support.

In an aspect, the activator-support can comprise fluorided alumina, chlorided alumina, bromided alumina, sulfated alumina, phosphated alumina, fluorided silica-alumina, chlorided silica-alumina, bromided silica-alumina, sulfated silica-alumina, phosphated silica-alumina, fluorided silica-zirconia, chlorided silica-zirconia, bromided silica-zirconia, sulfated silica-zirconia, fluorided silica-titania, fluorided silica-coated alumina, fluorided-chlorided silica-coated alumina, sulfated silica-coated alumina, phosphated silica-coated alumina, or any combination thereof. In another, the activator-support in the catalyst composition can comprise a fluorided solid oxide, a sulfated solid oxide, a phosphated solid oxide, or a combination thereof. In yet another aspect, the activator-support can comprise fluorided silica-alumina, fluorided silica-coated alumina, sulfated alumina, or any combination thereof.

Various processes can be used to form activator-supports useful in the present invention. Methods of contacting the solid oxide with the electron-withdrawing component, suitable electron withdrawing components and addition amounts, impregnation with metals or metal ions (e.g., zinc, nickel, vanadium, titanium, silver, copper, gallium, tin, tungsten, molybdenum, zirconium, and the like, or combinations thereof), and various calcining procedures and conditions are disclosed in, for example, U.S. Pat. Nos. 6,107,230, 6,165,929, 6,294,494, 6,300,271, 6,316,553, 6,355,594, 6,376,415, 6,388,017, 6,391,816, 6,395,666, 6,524,987, 6,548,441, 6,548,442, 6,576,583, 6,613,712, 6,632,894, 6,667,274, 6,750,302, 7,294,599, 7,601,665, 7,884,163, and 8,309,485. Other suitable processes and procedures for preparing activator-supports (e.g., fluorided solid oxides and sulfated solid oxides) are well known to those of skill in the art.

Referring now to the organoaluminum compound in the catalyst composition, any suitable organoaluminum compound can be utilized in any suitable amount. The organoaluminum compound can have the formula, Al(R^{Z})₃. In other aspects, suitable organoaluminum compounds can have the formula, Al(R^{Z})ₘ(X¹)₃₋ₘ. In the organoaluminum compounds Al(R^{Z})₃ and Al(R^{Z})ₘ(X¹)₃₋ₘ, each R^{Z} independently can be a hydrocarbyl; each X¹ independently can be an alkoxide or an aryloxide, a halide, or a hydride; and m can be from 1 to 3, inclusive. Hydrocarbyl is used herein to specify a hydrocarbon radical group and includes, for instance, aryl, alkyl, cycloalkyl, alkenyl, cycloalkenyl, cycloalkadienyl, alkynyl, aralkyl, aralkenyl, and aralkynyl groups. In one aspect, each R^{Z} independently can be any hydrocarbyl having from 1 to about 18 carbon atoms, or from 1 to about 8 carbon atoms, or an alkyl having from 1 to 10 carbon atoms. For example, each R^{Z} independently can be methyl, ethyl, propyl, n-butyl, sec-butyl, isobutyl, or hexyl, and the like, in certain aspect of the present invention. According to another aspect of the present invention, each X¹ independently can be an alkoxide or an aryloxide, any one of which has from 1 to 18 carbon atoms, a halide, or a hydride. In yet another aspect of the present invention, each X¹ can be selected independently from fluorine and chlorine. In the formula, Al(R^{Z})ₘ(X¹)₃₋ₘ, m can be a number from 1 to 3 (inclusive) and typically, m can be 3. The value of m is not restricted to be an integer; therefore, this formula can include sesquihalide compounds or other organoaluminum cluster compounds.

Non-limiting examples of organoaluminum compounds that can be utilized in the catalyst composition of the present invention include trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof. In a particular aspect, the organoaluminum compound can comprise triisobutylaluminum.

Generally, the weight ratio of the metallocene compound to the activator-support in the catalyst composition is not particularly limited. Nonetheless, this weight ratio often falls within a range from 1:1 to 1:100,000, such as from 1:10 to 1:10,000, from 1:1 to 1:1000, from 1:10 to 1:200, or from 1:10 to 1:50. Additionally or alternatively, the molar ratio of the trimethylaluminum (TMA) (present in the metallocene solution) to the organoaluminum compound in the catalyst composition can be in any suitable range, non-limiting examples of which include from 1:1 to 1:1000, from 1:1 to 1:500, from 1:10 to 1:1,000, from 1:10 to 1:500, from 1:1 to 1:50; from 1:1 to 1:20, or from 1:20 to 1:250, although not limited thereto. Likewise, the weight ratio of the activator-support to the organoaluminum compound in the catalyst composition is not particularly limited. Illustrative and non-limiting ranges of this weight ratio include from 100:1 to 1:100, from 10:1 to 1:10, from 5:1 to 1:5, or from 20:1 to 1:1.

In some aspects, the catalyst compositions and methods of their preparation are substantially free of aluminoxane compounds, organoboron or organoborate compounds, ionizing ionic compounds, and/or other similar materials; alternatively, substantially free of aluminoxanes; alternatively, substantially free or organoboron or organoborate compounds; or alternatively, substantially free of ionizing ionic compounds. In these aspects, the catalyst composition has catalyst activity in the absence of these additional materials. For example, a catalyst composition of the present invention can consist essentially of (i) a metallocene solution comprising trimethylaluminum, a C₄-C₈ alkane solvent, and a metallocene compound in an amount from 0.2 to 8 mg per mL of the metallocene solution, (ii) an activator-support, and (iii) an organoaluminum compound, wherein no other materials are present in the catalyst composition which would increase/decrease the activity of the catalyst composition by more than 10% from the catalyst activity of the catalyst composition in the absence of said materials.

### Polymerization Processes

A polymerization process consistent with this invention can comprise contacting a catalyst composition (any catalyst composition disclosed herein, and any metallocene solution disclosed herein) with ethylene and an optional olefin comonomer in a polymerization reactor system under polymerization conditions to produce an ethylene polymer. Often, the metallocene solution containing the metallocene compound, the C₄-C₈ alkane solvent, and the TMA can be fed to a catalyst preparation vessel than contains the activator-support and the organoaluminum compound to form the catalyst composition. In this aspect, the catalyst composition is effectively formed in the catalyst preparation vessel, prior to being fed to a reactor in the polymerization reactor system.

A “polymerization reactor” includes any polymerization reactor capable of polymerizing olefin monomers and comonomers (one or more than one comonomer) to produce homopolymers, copolymers, terpolymers, and the like. The various types of polymerization reactors include those that can be referred to as a batch reactor, slurry reactor, gas-phase reactor, solution reactor, high pressure reactor, tubular reactor, autoclave reactor, and the like, or combinations thereof; or alternatively, the polymerization reactor system can comprise a slurry reactor, a gas-phase reactor, a solution reactor, or a combination thereof. The polymerization conditions for the various reactor types are well known to those of skill in the art. Gas phase reactors can comprise fluidized bed reactors or staged horizontal reactors. Slurry reactors can comprise vertical or horizontal loops. High pressure reactors can comprise autoclave or tubular reactors. Reactor types can include batch or continuous processes. Continuous processes can use intermittent or continuous product discharge. Polymerization reactor systems and processes also can include partial or full direct recycle of unreacted monomer, unreacted comonomer, and/or diluent.

A polymerization reactor system can comprise a single reactor or multiple reactors (2 reactors, more than 2 reactors, etc.) of the same or different type. For instance, the polymerization reactor system can comprise a slurry reactor, a gas-phase reactor, a solution reactor, or a combination of two or more of these reactors. Production of polymers in multiple reactors can include several stages in at least two separate polymerization reactors interconnected by a transfer device making it possible to transfer the polymers resulting from the first polymerization reactor into the second reactor. The desired polymerization conditions in one of the reactors can be different from the operating conditions of the other reactor(s). Alternatively, polymerization in multiple reactors can include the manual transfer of polymer from one reactor to subsequent reactors for continued polymerization. Multiple reactor systems can include any combination including, but not limited to, multiple loop reactors, multiple gas phase reactors, a combination of loop and gas phase reactors, multiple high pressure reactors, or a combination of high pressure with loop and/or gas phase reactors. The multiple reactors can be operated in series, in parallel, or both. Accordingly, the present invention encompasses polymerization reactor systems comprising a single reactor, comprising two reactors, and comprising more than two reactors. The polymerization reactor system can comprise a slurry reactor, a gas-phase reactor, a solution reactor, in certain aspects of this invention, as well as multi-reactor combinations thereof.

Accordingly, the polymerization reactor system can comprise at least one loop slurry reactor comprising vertical or horizontal loops. Monomer, diluent, catalyst, and comonomer can be continuously fed to a loop reactor where polymerization occurs. Generally, continuous processes can comprise the continuous introduction of monomer/comonomer, a catalyst, and a diluent into a polymerization reactor and the continuous removal from this reactor of a suspension comprising polymer particles and the diluent. Reactor effluent can be flashed to remove the solid polymer from the liquids that comprise the diluent, monomer and/or comonomer. Various technologies can be used for this separation step including, but not limited to, flashing that can include any combination of heat addition and pressure reduction, separation by cyclonic action in either a cyclone or hydrocyclone, or separation by centrifugation.

A typical slurry polymerization process (also known as the particle form process) is disclosed, for example, in U.S. Pat. Nos. 3,248,179, 4,501,885, 5,565,175, 5,575,979, 6,239,235, 6,262,191, 6,833,415, and 8,822,608.

Suitable diluents used in slurry polymerization include, but are not limited to, the monomer being polymerized and hydrocarbons that are liquids under reaction conditions. Examples of suitable diluents include, but are not limited to, hydrocarbons such as propane, cyclohexane, isobutane, n-butane, n-pentane, isopentane, neopentane, and n-hexane. Some loop polymerization reactions can occur under bulk conditions where no diluent is used.

According to yet another aspect, the polymerization reactor system can comprise at least one gas phase reactor (e.g., a fluidized bed reactor). Such reactor systems can employ a continuous recycle stream containing one or more monomers continuously cycled through a fluidized bed in the presence of the catalyst under polymerization conditions. A recycle stream can be withdrawn from the fluidized bed and recycled back into the reactor. Simultaneously, polymer product can be withdrawn from the reactor and new or fresh monomer can be added to replace the polymerized monomer. Such gas phase reactors can comprise a process for multi-step gas-phase polymerization of olefins, in which olefins are polymerized in the gaseous phase in at least two independent gas-phase polymerization zones while feeding a catalyst-containing polymer formed in a first polymerization zone to a second polymerization zone. Representative gas phase reactors are disclosed in U.S. Pat. Nos. 5,352,749, 4,588,790, 5,436,304, 7,531,606, and 7,598,327.

According to still another aspect, the polymerization reactor system can comprise a high pressure polymerization reactor, e.g., can comprise a tubular reactor or an autoclave reactor. Tubular reactors can have several zones where fresh monomer, initiators, or catalysts are added. Monomer can be entrained in an inert gaseous stream and introduced at one zone of the reactor. Initiators, catalysts, and/or catalyst components can be entrained in a gaseous stream and introduced at another zone of the reactor. The gas streams can be intermixed for polymerization. Heat and pressure can be employed appropriately to obtain optimal polymerization reaction conditions.

According to yet another aspect, the polymerization reactor system can comprise a solution polymerization reactor wherein the monomer/comonomer are contacted with the catalyst composition by suitable stirring or other means. A carrier comprising an inert organic diluent or excess monomer can be employed. If desired, the monomer/comonomer can be brought in the vapor phase into contact with the catalytic reaction product, in the presence or absence of liquid material. The polymerization zone can be maintained at temperatures and pressures that will result in the formation of a solution of the polymer in a reaction medium. Agitation can be employed to obtain better temperature control and to maintain uniform polymerization mixtures throughout the polymerization zone. Adequate means are utilized for dissipating the exothermic heat of polymerization.

The polymerization reactor system can further comprise any combination of at least one raw material feed system, at least one feed system for catalyst or catalyst components, and/or at least one polymer recovery system. Suitable reactor systems can further comprise systems for feedstock purification, catalyst storage and preparation, extrusion, reactor cooling, polymer recovery, fractionation, recycle, storage, loadout, laboratory analysis, and process control. Depending upon the desired properties of the olefin polymer, hydrogen can be added to the polymerization reactor as needed (e.g., continuously, pulsed, etc.).

Polymerization conditions that can be controlled for efficiency and to provide desired polymer properties can include temperature, pressure, and the concentrations of various reactants. Polymerization temperature can affect catalyst productivity, polymer molecular weight, and molecular weight distribution. Various polymerization conditions can be held substantially constant, for example, for the production of a particular grade of the olefin polymer (or ethylene polymer). A suitable polymerization temperature can be any temperature below the de-polymerization temperature according to the Gibbs Free energy equation. Typically, this includes from 60° C. to 280° C., for example, or from 60° C. to 120° C., depending upon the type of polymerization reactor(s). In some reactor systems, the polymerization temperature generally can be within a range from 70° C. to 150° C., or from 75° C. to 100° C.

Suitable pressures will also vary according to the reactor and polymerization type. The pressure for liquid phase polymerizations in a loop reactor is typically less than 1000 psig (6.9 MPa). Pressure for gas phase polymerization is usually from 200 to 500 psig (1.4 MPa to 3.4 MPa). High pressure polymerization in tubular or autoclave reactors is generally run at 20,000 to 75,000 psig (138 to 517 MPa). Polymerization reactors can also be operated in a supercritical region occurring at generally higher temperatures and pressures. Operation above the critical point of a pressure/temperature diagram (supercritical phase) can offer advantages to the polymerization reaction process.

The concentration of the reactants entering the polymerization reactor can be controlled to produce resins with certain physical and mechanical properties. The proposed end-use product that will be formed by the polymer resin and the method of forming that product ultimately can determine the desired polymer properties and attributes. Mechanical properties include tensile, flexural, impact, creep, stress relaxation, and hardness tests. Physical properties include density, molecular weight, molecular weight distribution, melting temperature, glass transition temperature, temperature melt of crystallization, stereoregularity, crack growth, long chain branching, and rheological measurements.

Consistent with aspects of this invention, the olefin monomer used in the polymerization process is ethylene, and if used, the comonomer can comprise a C₃-C₂₀ alpha-olefin; alternatively, a C₃-C₁₀ alpha-olefin; alternatively, the comonomer can comprise 1-butene, 1-pentene, 1-hexene, 1-octene, 1-decene, styrene, or any combination thereof; alternatively, the comonomer can comprise 1-butene, 1-hexene, 1-octene, or any combination thereof; alternatively, the comonomer can comprise 1-butene; alternatively, the comonomer can comprise 1-hexene; or alternatively, the comonomer can comprise 1-octene. Thus, in an aspect, the catalyst composition can be contacted with ethylene and an olefin comonomer comprising a C₃-C₁₀ alpha-olefin to produce the ethylene polymer, while in another aspect, the catalyst composition can be contacted with ethylene and an olefin comonomer comprising 1-butene, 1-hexene, 1-octene, or a mixture thereof, to produce the ethylene polymer.

In one aspect, the ethylene polymer of this invention can comprise an ethylene/α-olefin copolymer, while in another aspect, the ethylene polymer can comprise an ethylene homopolymer, and in yet another aspect, the ethylene polymer of this invention can comprise an ethylene/α-olefin copolymer and an ethylene homopolymer. For example, the ethylene polymer can comprise an ethylene/1-butene copolymer, an ethylene/1-hexene copolymer, an ethylene/1-octene copolymer, an ethylene homopolymer, or any combination thereof; alternatively, an ethylene/1-butene copolymer, an ethylene/1-hexene copolymer, an ethylene/1-octene copolymer, or any combination thereof; or alternatively, an ethylene/1-hexene copolymer.

Also encompassed herein are the ethylene polymers produced by any of the polymerization processes disclosed herein. Articles of manufacture can be formed from, and/or can comprise, the ethylene polymers produced in accordance with the polymerization processes described herein.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Fluorided silica-coated alumina activator-supports (A-S) were prepared as follows. A slurry was made by mixing 400 mL of water and 100 g of silica-coated alumina (40 wt. % alumina, a surface area of 450 m²/g, a pore volume of 1.3 mL/g, and an average particle size of 35 microns). A solution of concentrated hydrofluoric acid (5 g HF) was mixed into the slurry, and the resulting slurry was then spray dried to a dry flowable powder. Calcining was performed at 600° C. by fluidizing the fluorided silica-coated alumina (4.75 wt. % fluoride) in dry nitrogen for 3 hr, followed by cooling to room temperature while still being fluidized under nitrogen.

Alternatively, sulfated alumina activator-supports can be used, and these activator-supports can be prepared as follows. An alumina having a surface area of 300 m²/g, a pore volume of 1.3 mL/g, and an average particle size of 100 microns, is calcined in air at 600° C. for 15 min and then allowed to cool. Next, 100 g of the alumina is impregnated with 300 mL of water into which 15 g of concentrated sulfuric acid is dissolved. The resulting damp powder is then dried overnight under vacuum at 100° C. Calcining is performed at 600° C. by fluidizing the sulfated alumina (14.7 wt. % sulfate) in dry nitrogen for 3 hr, followed by cooling to room temperature while still being fluidized under nitrogen.

The metallocene compounds used in the examples are abbreviated as follows: MET-1 is (η⁵-1-butylcyclopentadenyl)(η⁵-1-propen-2-yl-indenyl) zirconium dichloride; MET-2 is diphenylmethylidene(η⁵-(3-penten-4-yl)cyclopentadiene-1-yl)(η⁵-2,7-di-tert-butylfluoren-9-ylidene) hafnium dichloride; and MET-3 is methyl(buten-3-yl)methylidene(Is-cyclopentadienyl)(η⁵-2,7-di-tert-butylfluoren-9-ylidene) zirconium dichloride. The organoaluminum compounds used in the examples are abbreviated as follows: TIBA is triisobutylaluminum and TMA is trimethylaluminum.

Molecular weights and molecular weight distributions were obtained using a PL-GPC 220 (Polymer Labs, an Agilent Company) system equipped with a IR4 detector (Polymer Char, Spain) and three (3) Styragel HMW-6E GPC columns (Waters, MA) running at 145° C. The flow rate of the mobile phase 1,2,4-trichlorobenzene (TCB) containing 0.5 g/L 2,6-di-t-butyl-4-methylphenol (BHT) was set at 1 mL/min, and polymer solution concentrations were approximately 1 mg/mL, depending on the molecular weight. Sample preparation was conducted at 150° C. for nominally 4 hr with occasional and gentle agitation, before the solutions were transferred to sample vials for injection. An injection volume of about 400 μL was used. The integral calibration method was used to deduce molecular weights and molecular weight distributions using a broad Chevron Phillips Chemical Company's HDPE polyethylene resin, MARLEX BHB5003, as the standard. The integral table of the standard was pre-determined in a separate experiment with SEC-MALS. Mn is the number-average molecular weight, Mw is the weight-average molecular weight, Mz is the z-average molecular weight, and Mp is the peak molecular weight (location, in molecular weight, of the highest point of the molecular weight distribution curve).

Melt rheological characterizations were performed as follows. Small-strain (10%) oscillatory shear measurements were performed on an Anton Paar MCR 501 rheometer using parallel-plate geometry. All rheological tests were performed at 190° C. The complex viscosity |η*| versus frequency (ω) data were then curve fitted using the modified three parameter Carreau-Yasuda (CY) empirical model to obtain the zero shear viscosity—η₀, characteristic viscous relaxation time—τ_{η}, and the breadth parameter—a (CY-a parameter). The simplified Carreau-Yasuda (CY) empirical model is as follows.

$$\vert η * ( ω ) \vert = \frac{{η}_{0}}{{[ 1 + {( {τ}_{n} ω )}^{a} ]}^{( 1 - n ) / a}} ,$$

$$wherein :$$

$$\vert η * ( ω ) \vert = magnitude of complex shear viscosity ;$$

$${η}_{0} = zero shear viscosity ;$$

$${τ}_{η} = viscous relaxation time ( Tau ( η ) in sec ) ;$$

$$a = “ breadth ” parameter ( CY - a parameter ) ;$$

$$n = fixes the final power law slope , fixed at 2 / 11 ; and$$

$$ω = angular frequency of oscillatory shearing deformation .$$

Details of the significance and interpretation of the CY model and derived parameters can be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong and O. Hasseger, Dynamics of Polymeric Liquids, Volume 1, Fluid Mechanics, 2nd Edition, John Wiley & Sons (1987).

### Examples 1-36 and Comparative Examples C1-C16

Table I summarizes metallocene solutions A-O, Table II summarizes Examples 1-5 and Comparative Examples C1-C2 utilizing MET-1 solutions A-C, Table III summarizes Examples 6-20 and Comparative Examples C4-C10 utilizing MET-1 solutions D-G, Table IV summarizes Examples 21-28 and Comparative Examples C11-C14 utilizing MET-2 solutions H-J, Table V summarizes Examples 29-32 and Comparative Examples C15-C16 utilizing MET-3 solutions K-M, Table VI summarizes Examples 33-36 comparing TIBA versus TMA in MET-3 solutions N-O, Table VII summarizes the molecular weight and rheology data for polymers produced from MET-1 solutions D-G, and Table VIII summarizes the molecular weight and rheology data for polymers produced from MET-2 solutions H-J.

Metallocene solutions were prepared at room temperature and atmospheric pressure in a 10 mL volumetric flask by first dissolving or slurrying 10 mg of a metallocene compound in 5 mL of heptane. Next, 0.07 mL of an alkyl aluminum compound was added and swirled to dissolve. For metallocene solutions C, E-G, I-J, L-M, and O, the alkyl aluminum compound was TMA. For metallocene solutions B and N, the alkyl aluminum compound was TIBA. Heptane was then added to the 10 mL mark and the solution was stirred with a stir bar for 15 minutes to dissolve all the metallocene compound. The exception was metallocene solutions A, D, H, and K, which were prepared by dissolving or slurrying 10 mg of a metallocene compound in 10 mL of toluene. MET-1 compound was utilized for metallocene solutions A-G, MET-2 compound was utilized for metallocene solutions H-J, and MET-3 compound was utilized for metallocene solutions K-O, as shown in Table I. Solutions were stored without exposure to light prior to use.

The polymerization experiments of Examples 1-36 and Comparative Examples C1-C16 are summarized in Tables II-VI and were conducted for 25-30 minutes in a one-gallon (3.8 L) stainless-steel autoclave reactor containing isobutane as diluent. The desired amount of activator-support (A-S), 0.4 mL of TIBA (1.0 M in heptane), and the desired amount of metallocene solution were added in that order through a charge port while slowly venting isobutane vapor to form the catalyst compositions of Examples 1-36 and Comparative Examples C1-C16. The charge port was then closed, and isobutane was added. The contents of the reactor were stirred and heated to the desired run temperature of 90-100° C., and ethylene was then introduced into the reactor. Ethylene was fed on demand to maintain the target pressure of 390-450 psig (2.7-3.1 MPa). The reactor was maintained at the desired temperature throughout the experiment by an automated heating-cooling system. After venting of the reactor, purging, and cooling, the resulting polymer product was dried at 50° C. under vacuum.

For Examples 3-5, where heptane was utilized as the hydrocarbon solvent in the MET-1 metallocene solutions, the catalyst activity (based on either the metallocene compound or the activator-support) was comparable to or slightly greater than Comparative Examples C1-C2, where toluene was utilized as the hydrocarbon solvent, as shown in Table II. Notably, the catalyst activity unexpectedly decreased to almost half of its starting value after two weeks of storage (Examples 1-2), where TIBA was utilized in the MET-1 metallocene solutions instead of TMA. Advantageously, the data in Table II suggests that the MET-1 metallocene solutions with TMA are stable and did not decrease in catalytic activity. Further, and surprisingly, the data in Table III demonstrates that the inventive MET-1 metallocene solutions in Examples 6-20 (over a large range of TMA loadings and for storage periods from a few days to 2 months) advantageously maintained similar activity to that of Comparative Examples C4-C10 where toluene was utilized as the hydrocarbon solvent.

Table IV summarizes the polymerization experiments utilizing MET-2 metallocene solutions H-J. Examples 21-28, where heptane and TMA were utilized in MET-2 metallocene solutions I-J, demonstrated comparable catalyst activity to Comparative Examples C11-C14, where toluene was utilized as the hydrocarbon solvent. Moreover, the inventive MET-2 metallocene solutions in Examples 21-28 (over a large range of TMA loadings and for storage periods from a week to a month) did not exhibit a significant decrease in catalyst activity over time, consistent with Comparative Examples C11-C14.

Similarly, Table V summarizes the polymerization experiments utilizing MET-2 metallocene solutions K-M. Examples 29-32, where heptane and TMA were utilized in metallocene solutions L-M, exhibited slightly lower but still comparable catalyst activity to Comparative Examples C15-C16, where toluene was utilized as the hydrocarbon solvent. Moreover, the inventive MET-3 metallocene solutions in Examples 29-32 (over a large range of TMA loadings and for storage periods up to 17 days) did not exhibit a significant decrease in catalyst activity over time.

The catalyst activities of catalyst systems utilizing MET-3 metallocene solutions with either TMA or TIBA were directly compared in Table VI. Examples 33-36 demonstrate that the use of TIBA in the metallocene solution resulted in a significant decrease in activity of 25% within a week (Example 35). In contrast, when TMA was used in the MET-3 metallocene solution, no significant decrease in activity over the same time period was noted (Example 36). Thus, while excellent metallocene solubility was obtained with heptane and either TMA or TIBA, the beneficial improvements in storage stability—unexpectedly—were only obtained with TMA.

Advantageously, the polymer characterization data in Table VII demonstrates that the polymers produced from MET-1 solutions E-G, where heptane and TMA were utilized, were substantially the same as the polymers produced from MET-1 solution D, where toluene was utilized as the hydrocarbon solvent. Likewise, the polymer characterization data in Table VIII demonstrates that the polymer produced from MET-2 solutions I-J, where heptane and TMA were utilized, were substantially the same as the polymers produced from MET-2 solution H, where toluene was utilized as the hydrocarbon solvent. Notably, these examples demonstrate the ability to use heptane and TMA as a drop-in replacement for toluene in the preparation of metallocene solutions, and with the unexpected benefit of long-term storage stability.

TABLE I
Metallocene Solutions A-O.

| | | Alkyl | Molar ratio | | mg | |
|---|---|---|---|---|---|---|
| | | Aluminum | of Al:Hf or | | MET/ | MET |
| | Metallocene | (Organo- | Al:Zr in | | mL | Concentration |
| Solution | Compound | aluminum) | solution | Solvent | solution | (wt. %) |
| A | MET-1 | — | — | toluene | 1.00 | 0.144 |
| B | MET-1 | TIBA | 3 | heptane | 1.00 | 0.146 |
| C | MET-1 | TMA | 3 | heptane | 1.00 | 0.146 |
| D | MET-1 | — | — | toluene | 1.39 | 0.20 |
| E | MET-1 | TMA | 2 | heptane | 1.37 | 0.20 |
| F | MET-1 | TMA | 5 | heptane | 1.37 | 0.20 |
| G | MET-1 | TMA | 10 | heptane | 1.37 | 0.20 |
| H | MET-2 | — | — | toluene | 2.17 | 0.30 |
| I | MET-2 | TMA | 5 | heptane | 2.06 | 0.30 |
| J | MET-2 | TMA | 10 | heptane | 2.06 | 0.30 |
| K | MET-3 | — | — | toluene | 2.09 | 0.30 |
| L | MET-3 | TMA | 2 | heptane | 2.06 | 0.30 |
| M | MET-3 | TMA | 5 | heptane | 2.06 | 0.30 |
| N | MET-3 | TIBA | 3 | heptane | 1.00 | 0.146 |
| O | MET-3 | TMA | 3 | heptane | 1.00 | 0.146 |

TABLE II
Examples 1-5 and Comparative Examples C1-C2 utilizing MET-1 solutions A-C.

| | | Solution | Catalyst | | TIBA | | | Metallocene | | | |
|---|---|---|---|---|---|---|---|---|---|---|---|
| | MET-1 | Storage | Solution | MET-1 | (mL, | A-S | Polymer | Activity | A-S Activity | Delta | Delta |
| Example | Solution | (Days) | (mL) | (mg) | 1M) | (mg) | (g) | (g/(g*hr)) | (g/(g*hr) | Met | A-S |
| C1 | A | 1 | 1 | 1 | 0.4 | 325 | 225 | 450,000 | 1,385 | — | — |
| C2 | A | 11 | 1 | 1 | 0.4 | 292 | 244 | 488,000 | 1,671 | 108% | 121% |
| 1 | B | 1 | 1 | 1 | 0.4 | 308 | 204 | 408,000 | 1,325 | — | — |
| 2 | B | 15 | 1 | 1 | 0.4 | 319 | 126 | 252,000 | 790 | 62% | 60% |
| 3 | C | 2 | 1 | 1 | 0.4 | 320 | 245 | 490,000 | 1,531 | — | — |
| 4 | C | 15 | 1 | 1 | 0.4 | 308 | 283 | 566,000 | 1,838 | 116% | 120% |
| 5 | C | 22 | 1 | 1 | 0.4 | 309 | 267 | 534,000 | 1,728 | 109% | 113% |

Table II Notes.
All polymerization runs were conducted for 30 minutes. The reactor was maintained at 95° C. and ethylene was fed on demand to maintain a reactor pressure of 420 psig (2.9 MPa).

TABLE III
Examples 6-20 and Comparative Examples C4-C10 utilizing MET-1 solutions D-G.

| | | Solution | Catalyst | | TIBA | | | Metallocene | A-S | | |
|---|---|---|---|---|---|---|---|---|---|---|---|
| | MET-1 | Storage | Solution | MET- | (mL, | A-S | Polymer | Activity | Activity | Delta | Delta |
| Example | Solution | (Days) | (mL) | 1 (mg) | 1M) | (mg) | (g) | (g/(g*hr)) | (g/(g*hr) | Met | A-S |
| C4 | D | 1 | 0.5 | 0.695 | 0.4 | 295 | 175 | 503,597 | 1,186 | — | — |
| C5 | D | 2 | 0.5 | 0.695 | 0.4 | 330 | 210 | 604,317 | 1,273 | — | — |
| C6 | D | 8 | 0.5 | 0.695 | 0.4 | 309 | 170 | 489,209 | 1,100 | — | — |
| C7 | D | 19 | 0.5 | 0.695 | 0.4 | 315 | 197 | 566,906 | 1,251 | — | — |
| C8 | D | 36 | 0.5 | 0.695 | 0.4 | 299 | 132 | 379,856 | 883 | — | — |
| C9 | D | 38 | 0.5 | 0.695 | 0.4 | 299 | 141 | 405,755 | 943 | — | — |
| C10 | D | 59 | 0.5 | 0.695 | 0.4 | 309 | 131 | 376,978 | 848 | — | — |
| 6 | E | 2 | 0.5 | 0.685 | 0.4 | 303 | 186 | 543,066 | 1,228 | — | — |
| 7 | E | 9 | 0.5 | 0.685 | 0.4 | 308 | 176 | 513,869 | 1,143 | 95% | 93% |
| 8 | E | 20 | 0.5 | 0.685 | 0.4 | 306 | 179 | 522,628 | 1,170 | 96% | 95% |
| 9 | E | 39 | 0.5 | 0.685 | 0.4 | 293 | 148 | 432,117 | 1,010 | 80% | 82% |
| 10 | E | 59 | 0.5 | 0.685 | 0.4 | 325 | 161 | 470,073 | 991 | 87% | 81% |
| 11 | F | 2 | 0.5 | 0.685 | 0.4 | 319 | 173 | 505,109 | 1,085 | — | — |
| 12 | F | 9 | 0.5 | 0.685 | 0.4 | 302 | 188 | 548,905 | 1,245 | 109% | 115% |
| 13 | F | 20 | 0.5 | 0.685 | 0.4 | 311 | 198 | 578,102 | 1,273 | 114% | 117% |
| 14 | F | 39 | 0.5 | 0.685 | 0.4 | 305 | 150 | 437,956 | 984 | 87% | 91% |
| 15 | F | 59 | 0.5 | 0.685 | 0.4 | 308 | 141 | 411,679 | 916 | 82% | 84% |
| 16 | G | 2 | 0.5 | 0.685 | 0.4 | 328 | 210 | 613,139 | 1,280 | — | — |
| 17 | G | 9 | 0.5 | 0.685 | 0.4 | 309 | 191 | 557,664 | 1,236 | 91% | 97% |
| 18 | G | 21 | 0.5 | 0.685 | 0.4 | 312 | 185 | 540,146 | 1,186 | 88% | 93% |
| 19 | G | 44 | 0.5 | 0.685 | 0.4 | 292 | 132 | 385,401 | 904 | 63% | 71% |
| 20 | G | 60 | 0.5 | 0.685 | 0.4 | 287 | 132 | 385,401 | 920 | 63% | 72% |

TABLE IV
Examples 21-28 and Comparative Examples C11-C14 utilizing MET-2 solutions H-J.

| | | Solution | Catalyst | | TIBA | | | Metallocene | A-S | | |
|---|---|---|---|---|---|---|---|---|---|---|---|
| | MET-2 | Storage | Solution | MET-2 | (mL, | A-S | Polymer | Activity | Activity | Delta | Delta |
| Example | Solution | (Days) | (mL) | (mg) | 1M) | (mg) | (g) | (g/(g*hr)) | (g/(g*hr) | Met | A-S |
| C11 | H | 1 | 0.5 | 1.085 | 0.4 | 397 | 111 | 204,608 | 559 | — | — |
| C12 | H | 7 | 0.5 | 1.085 | 0.4 | 415 | 83 | 152,995 | 400 | — | — |
| C13 | H | 24 | 0.5 | 1.085 | 0.4 | 401 | 85 | 156,682 | 424 | — | — |
| C14 | H | 27 | 0.5 | 1.085 | 0.4 | 404 | 92 | 169,585 | 455 | — | — |
| 21 | I | 1 | 0.5 | 1.03 | 0.4 | 397 | 117 | 227,184 | 589 | — | — |
| 22 | I | 7 | 0.5 | 1.03 | 0.4 | 411 | 76 | 147,573 | 370 | 65% | 63% |
| 23 | I | 23 | 0.5 | 1.03 | 0.4 | 403 | 95 | 184,466 | 471 | 81% | 80% |
| 24 | I | 28 | 0.5 | 1.03 | 0.4 | 413 | 91 | 176,699 | 441 | 78% | 75% |
| 25 | J | 1 | 0.5 | 1.03 | 0.4 | 394 | 105 | 203,883 | 533 | — | — |
| 26 | J | 8 | 0.5 | 1.03 | 0.4 | 411 | 96 | 186,408 | 467 | 91% | 88% |
| 27 | J | 23 | 0.5 | 1.03 | 0.4 | 413 | 81 | 157,282 | 392 | 77% | 74% |
| 28 | J | 29 | 0.5 | 1.03 | 0.4 | 409 | 80 | 155,340 | 391 | 76% | 73% |

Table IV Notes.
All polymerization runs were conducted for 30 minutes. The reactor was maintained at 100° C. and ethylene was fed on demand to maintain a reactor pressure of 450 psig (2.9 MPa).

TABLE V
Examples 29-32 and Comparative Examples C15-C16 utilizing MET-3 solutions K-M.

| | | Solution | Catalyst | | TIBA | | | Metallocene | A-S | | |
|---|---|---|---|---|---|---|---|---|---|---|---|
| | MET-3 | Storage | Solution | MET-3 | (mL, | A-S | Polymer | Activity | Activity | Delta | Delta |
| Example | Solution | (Days) | (mL) | (mg) | 1M) | (mg) | (g) | (g/(g*hr)) | (g/(g*hr) | Met | A-S |
| C15 | K | 1 | 0.5 | 1.045 | 0.4 | 309 | 272 | 520,574 | 1,761 | — | — |
| C16 | K | 16 | 0.5 | 1.045 | 0.4 | 298 | 288 | 551,196 | 1,933 | — | — |
| 29 | L | 1 | 0.5 | 1.03 | 0.4 | 303 | 228 | 442,718 | 1,505 | — | — |
| 30 | L | 17 | 0.5 | 1.03 | 0.4 | 305 | 220 | 427,184 | 1,443 | 96% | 96% |
| 31 | M | 3 | 0.5 | 1.03 | 0.4 | 307 | 229 | 444,660 | 1,492 | — | — |
| 32 | M | 17 | 0.5 | 1.03 | 0.4 | 296 | 231 | 448,544 | 1,561 | 101% | 105% |

Table V Notes.
All polymerization runs were conducted for 30 minutes. The reactor was maintained at 90° C. and ethylene was fed on demand to maintain a reactor pressure of 390 psig (2.9 MPa).

TABLE VI
Examples 33-36 comparing TIBA versus TMA in MET-3 solutions N-O.

| | | Solution | Catalyst | | TIBA | | | Metallocene | A-S | | |
|---|---|---|---|---|---|---|---|---|---|---|---|
| | MET-3 | Storage | Solution | MET-3 | (mL, | A-S | Polymer | Activity | Activity | Delta | Delta |
| Example | Solution | (Days) | (mL) | (mg) | 1M) | (mg) | (g) | (g/(g*hr)) | (g/(g*hr) | Met | A-S |
| 33 | N | 1 | 1 | 1 | 0.4 | 300 | 383 | 919,200 | 3,064 | — | — |
| 34 | O | 1 | 1 | 1 | 0.4 | 300 | 442 | 1,060,800 | 3,536 | — | — |
| 35 | N | 8 | 1 | 1 | 0.4 | 300 | 288 | 691,200 | 2,304 | 75% | 75% |
| 36 | O | 8 | 1 | 1 | 0.4 | 300 | 425 | 1,020,000 | 3,400 | 96% | 96% |

Table VI Notes.
All polymerization runs were conducted for 25 minutes. The reactor was maintained at 90° C. and ethylene was fed on demand to maintain a reactor pressure of 390 psig (2.9 MPa).

TABLE VII
Characterization of polymers made from MET-1 solutions D-G.

| | | | | | | | | η₀ | τ_{η} | |
|---|---|---|---|---|---|---|---|---|---|---|
| Example | Mn/1000 | Mw/1000 | Mz/1000 | Mv/1000 | Mp/1000 | Mw/Mn | Mz/Mw | (Pa-sec) | (sec) | CY-a |
| C6 | 79.89 | 190.58 | 341.94 | 320.45 | 152.59 | 2.39 | 0.981 | 27,000 | 0.0415 | 0.564 |
| C7 | 76.78 | 186.20 | 336.10 | 314.75 | 154.56 | 2.43 | 0.985 | 25,800 | 0.0392 | 0.573 |
| 7 | 80.29 | 192.48 | 344.53 | 323.09 | 150.65 | 2.40 | 0.983 | 28,500 | 0.0435 | 0.564 |
| 8 | 80.99 | 192.39 | 343.90 | 322.55 | 150.65 | 2.38 | 0.981 | 28,900 | 0.0435 | 0.563 |
| 12 | 75.54 | 187.96 | 343.39 | 320.79 | 150.65 | 2.49 | 0.988 | 27,000 | 0.0413 | 0.565 |
| 13 | 78.64 | 188.34 | 335.30 | 314.85 | 154.56 | 2.39 | 0.983 | 26,600 | 0.0419 | 0.566 |
| 17 | 75.99 | 189.20 | 344.63 | 322.30 | 148.74 | 2.49 | 0.990 | 27,300 | 0.0414 | 0.571 |
| 18 | 76.62 | 187.69 | 338.81 | 317.29 | 152.59 | 2.45 | 0.986 | 24,900 | 0.0384 | 0.567 |

TABLE VIII
Characterization of polymers made from MET-2 solutions H-J.

| | | | | | | | | η₀ | τ_{η} | |
|---|---|---|---|---|---|---|---|---|---|---|
| Example | Mn/1000 | Mw/1000 | Mz/1000 | Mv/1000 | Mp/1000 | Mw/Mn | Mz/Mw | (Pa-sec) | (sec) | CY-a |
| C11 | 333.67 | 849.79 | 2088 | 1878 | 469.13 | 2.55 | 0.965 | 8,190,000 | 14.2 | 0.951 |
| 21 | 304.05 | 772.81 | 1933 | 1732 | 429.82 | 2.54 | 0.979 | 8,930,000 | 16.5 | 0.782 |
| 25 | 304.89 | 794.59 | 1927 | 1738 | 463.30 | 2.61 | 0.997 | 12,400,000 | 23.1 | 0.698 |

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of” unless specifically stated otherwise):

Aspect 1. A metallocene solution comprising (a) trimethylaluminum (TMA), (b) a C₄-C₈ alkane solvent, and (c) a metallocene compound in an amount from 0.2 to 8 mg per mL of the metallocene solution.

Aspect 2. The solution defined in aspect 1, wherein the alkane solvent comprises any suitable C₄-C₈ alkane, e.g., butane (e.g., n-butane or iso-butane), pentane (e.g., n-pentane, neopentane, cyclopentane, or isopentane), hexane (e.g., hexane or cyclohexane), heptane (e.g., n-heptane or cycloheptane), octane (e.g., n-octane or iso-octane), or any combination thereof; or alternatively, n-heptane.

Aspect 3. The solution defined in aspect 1 or 2, wherein the amount of the metallocene compound, based on the volume of the metallocene solution, is in any suitable range, e.g., from 0.2 to 5 mg/mL, from 0.5 to 8 mg/mL from 0.5 to 5 mg/mL from 0.5 to 3 mg/mL, from 0.5 to 2.5 mg/mL, from 0.75 to 8 mg/mL, from 0.75 to 3 mg/mL, from 0.75 to 2.25 mg/mL, from 1 to 3 mg/mL, or from 1 to 2.5 mg/mL.

Aspect 4. The solution defined in any one of aspects 1-3, wherein the metallocene solution contains any suitable amount of the metallocene compound, e.g., from 0.02 to 1 wt. %, from 0.02 to 0.7 wt. %, from 0.02 to 0.5 wt. %, from 0.05 to 1 wt. %, from 0.05 to 0.7 wt. %, from 0.05 to 0.5 wt. %, from 0.1 to 1 wt. %, from 0.1 to 0.7 wt. %, or from 0.1 to 0.4 wt. %, based on the total weight of the metallocene solution.

Aspect 5. The solution defined in any one of aspects 1-4, wherein a molar ratio of aluminum of the TMA to a transition metal of the metallocene compound is in any suitable range of molar ratios, e.g., from 0.5:1 to 100:1, from 0.5:1 to 25:1, from 1:1 to 75:1, from 1:1 to 15:1, from 1:1 to 10:1, from 2:1 to 50:1, from 2:1 to 15:1, from 2:1 to 10:1, or from 2:1 to 5:1.

Aspect 6. The solution defined in any one of aspects 1-5, wherein the metallocene compound comprises any suitable bridged metallocene compound or any bridged metallocene compound disclosed herein.

Aspect 7. The solution defined in any one of aspects 1-6, wherein the metallocene compound comprises a bridged zirconium or hafnium based metallocene compound with a fluorenyl group.

Aspect 8. The solution defined in any one of aspects 1-6, wherein the metallocene compound comprises a bridged zirconium or hafnium based metallocene compound with a cyclopentadienyl group and a fluorenyl group.

Aspect 9. The solution defined in any one of aspects 1-6, wherein the metallocene compound comprises a bridged zirconium or hafnium based metallocene compound with a fluorenyl group, and an aryl group and/or an alkenyl group on the bridging group.

Aspect 10. The solution defined in any one of aspects 1-6, wherein the metallocene compound comprises a bridged zirconium or hafnium based metallocene compound with a cyclopentadienyl group and a fluorenyl group, and an aryl group and/or an alkenyl group on the bridging group.

Aspect 11. The solution defined in aspect 9 or 10, wherein the aryl group is a phenyl group and the alkenyl group is a terminal alkenyl group.

Aspect 12. The solution defined in any one of aspects 7-11, wherein the fluorenyl group is unsubstituted or the fluorenyl group is an alkyl-substituted fluorenyl group (one or more alkyl substituents).

Aspect 13. The solution defined in any one of aspects 8-12, wherein the cyclopentadienyl group is unsubstituted or the cyclopentadienyl group is an alkenyl-substituted cyclopentadienyl group (one or more alkenyl substituents).

Aspect 14. The solution defined in any one of aspects 1-13, wherein the metallocene compound comprises any suitable unbridged metallocene compound or any unbridged metallocene compound disclosed herein.

Aspect 15. The solution defined in any one of aspects 1-14, wherein the metallocene compound comprises an unbridged zirconium based metallocene compound containing a cyclopentadienyl group and an indenyl group.

Aspect 16. The solution defined in aspect 15, wherein the indenyl group is unsubstituted or the indenyl group is an alkenyl-substituted indenyl group (one or more alkenyl substituents).

Aspect 17. The solution defined in aspect 15 or 16, wherein the cyclopentadienyl group is unsubstituted or the cyclopentadienyl group is an alkyl-substituted cyclopentadienyl group (one or more alkyl substituents).

Aspect 18. The solution defined in any one of aspects 1-17, wherein the metallocene solution comprises two or more metallocene compounds.

Aspect 19. The solution defined in any one of aspects 1-18, wherein the metallocene compound is (η⁵-1-butylcyclopentadenyl)(η⁵-1-propen-2-yl-indenyl) zirconium dichloride, diphenylmethylidene(η⁵-(3-penten-4-yl)cyclopentadiene-1-yl)(η⁵-2,7-di-tert-butylfluoren-9-ylidene) hafnium dichloride, methyl(buten-3-yl)methylidene(η⁵-cyclopentadienyl)(η⁵-2,7-di-tert-butylfluoren-9-ylidene) zirconium dichloride, rac-1,2-ethylenebis(η⁵-1-indenyl) zirconium dichloride, rac-dimethylsilylbis(η⁵-1-indenyl) zirconium dichloride, diphenylmethylidene(η⁵-(3-penten-4-yl)cyclopentadiene-1-yl)(η⁵-2,7-di-tert-butylfluoren-9-ylidene) zirconium dichloride, diethylmethylidene(η⁵-cyclopentadienyl)(η⁵-3-n-propylinden-1-yl) zirconium dichloride, bis(η⁵-indenyl) zirconium dichloride, bis(η⁵-n-butylcyclopentadienyl) zirconium dichloride, or any combination thereof.

Aspect 20. The solution defined in any one of aspects 1-19, wherein the metallocene solution is stable at room temperature (25° C., inert atmosphere, no exposure to light) for any suitable time period, e.g., at least 3 days, at least 5 days, at least 7 days, at least 9 days, at least 14 days, at least 20 days, at least 25 days, or at least 28 days.

Aspect 21. A catalyst composition comprising (i) the metallocene solution defined in any one of aspects 1-20, (ii) an activator-support, and (iii) an organoaluminum compound.

Aspect 22. The composition defined in aspect 21, wherein the activator-support comprises a solid oxide treated with an electron-withdrawing anion, for example, comprising any suitable solid oxide treated with any suitable electron-withdrawing anion.

Aspect 23. The composition defined in aspect 22, wherein the solid oxide comprises silica, alumina, silica-alumina, silica-coated alumina, aluminum phosphate, aluminophosphate, heteropolytungstate, titania, zirconia, magnesia, boria, zinc oxide, a mixed oxide thereof, or any mixture thereof; and the electron-withdrawing anion comprises sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, tungstate, molybdate, or any combination thereof.

Aspect 24. The composition defined in any one of aspects 21-23, wherein the activator-support comprises a fluorided solid oxide, a sulfated solid oxide, a phosphated solid oxide, or a combination thereof.

Aspect 25. The composition defined in any one of aspects 21-23, wherein the activator-support comprises fluorided alumina, chlorided alumina, bromided alumina, sulfated alumina, phosphated alumina, fluorided silica-alumina, chlorided silica-alumina, bromided silica-alumina, sulfated silica-alumina, phosphated silica-alumina, fluorided silica-zirconia, chlorided silica-zirconia, bromided silica-zirconia, sulfated silica-zirconia, fluorided silica-titania, fluorided silica-coated alumina, fluorided-chlorided silica-coated alumina, sulfated silica-coated alumina, phosphated silica-coated alumina, or any combination thereof.

Aspect 26. The composition defined in any one of aspects 21-23, wherein the activator-support comprises fluorided silica-alumina, fluorided silica-coated alumina, sulfated alumina, or any combination thereof.

Aspect 27. The composition defined in any one of aspects 21-26, wherein the activator-support contains from 1 to 30 wt. %, from 2 to 20 wt. %, from 2 to 15 wt. %, from 2 to 10 wt. %, or from 3 to 10 wt. %, of the electron-withdrawing anion, based on the total weight of the activator-support.

Aspect 28. The composition defined in any one of aspects 21-27, wherein the organoaluminum compound comprises any suitable organoaluminum compound, e.g., trimethylaluminum, triethylaluminum, tri-n-propylaluminum, tri-n-butylaluminum, triisobutylaluminum, tri-n-hexylaluminum, tri-n-octylaluminum, diisobutylaluminumhydride, diethylaluminum ethoxide, diethylaluminum chloride, or any combination thereof.

Aspect 29. The composition defined in any one of aspects 21-28, wherein the organoaluminum compound comprises triisobutylaluminum.

Aspect 30. The composition defined in any one of aspects 21-29, wherein a weight ratio of the metallocene compound to the activator-support is in any suitable range of weight ratios, e.g., from 1:1 to 1:100,000, from 1:10 to 1:10,000, from 1:1 to 1:1000, from 1:10 to 1:200, or from 1:10 to 1:50.

Aspect 31. The composition defined in any one of aspects 21-30, wherein a molar ratio of the TMA to the organoaluminum compound is in any suitable range of molar ratios, e.g., from 1:1 to 1:1000, from 1:1 to 1:500, from 1:10 to 1:1,000, from 1:10 to 1:500, from 1:1 to 1:50; from 1:1 to 1:20, or from 1:20 to 1:250.

Aspect 32. The composition defined in any one of aspects 21-31, wherein the weight ratio of the activator-support to the organoaluminum compound is in any suitable range of weight ratios, e.g., from 100:1 to 1:100, from 10:1 to 1:10, from 5:1 to 1:5, or from 20:1 to 1:1.

Aspect 33. The composition defined in any one of aspects 21-32, wherein the catalyst composition is substantially free of aluminoxane compounds, organoboron or organoborate compounds, ionizing ionic compounds, or combinations thereof.

Aspect 34. A polymerization process comprising contacting the catalyst composition defined in any one of aspects 21-33 with ethylene and an optional olefin comonomer in a polymerization reactor system under polymerization conditions to produce an ethylene polymer.

Aspect 35. The polymerization process defined in aspect 34, wherein the optional olefin comonomer comprises a C₃-C₂₀ alpha-olefin.

Aspect 36. The polymerization process defined in aspect 34 or 35, wherein the catalyst composition is contacted with ethylene and an olefin comonomer comprising a C₃-C₁₀ alpha-olefin.

Aspect 37. The polymerization process defined in any one of aspects 34-36, wherein the catalyst composition is contacted with ethylene and an olefin comonomer comprising 1-butene, 1-hexene, 1-octene, or a mixture thereof.

Aspect 38. The polymerization process defined in any one of aspects 34-37, wherein the polymerization reactor system comprises a batch reactor, a slurry reactor, a gas-phase reactor, a solution reactor, a high pressure reactor, a tubular reactor, an autoclave reactor, or a combination thereof.

Aspect 39. The polymerization process defined in any one of aspects 34-38, wherein the polymerization reactor system comprises a slurry reactor, a gas-phase reactor, a solution reactor, or a combination thereof.

Aspect 40. The polymerization process defined in any one of aspects 34-39, wherein the polymerization reactor system comprises a loop slurry reactor.

Aspect 41. The polymerization process defined in any one of aspects 34-40, wherein the polymerization reactor system comprises a single reactor.

Aspect 42. The polymerization process defined in any one of aspects 34-40, wherein the polymerization reactor system comprises 2 reactors.

Aspect 43. The polymerization process defined in any one of aspects 34-40, wherein the polymerization reactor system comprises more than 2 reactors.

Aspect 44. The polymerization process defined in any one of aspects 34-43, wherein the ethylene polymer comprises an ethylene homopolymer, an ethylene/1-butene copolymer, an ethylene/1-hexene copolymer, an ethylene/1-octene copolymer, or any combination thereof.

Aspect 45. The polymerization process defined in any one of aspects 34-44, wherein the ethylene polymer comprises an ethylene/1-hexene copolymer.

Aspect 46. The ethylene polymer produced by the polymerization process defined in any one of aspects 34-45.

Aspect 47. An article comprising the ethylene polymer defined in aspect 46.

We claim:

1. A metallocene solution comprising:
(a) trimethylaluminum (TMA);
(b) a C₄-C₈ alkane solvent; and
(c) a metallocene compound in an amount from 0.2 to 8 mg per mL of the metallocene solution.

2. The metallocene solution of claim 1, wherein the C₄-C₈ alkane solvent comprises butane, pentane, hexane, heptane, octane, or any combination thereof.

3. The metallocene solution of claim 1, wherein:
the metallocene solution contains from 0.02 to 1 wt. % of the metallocene compound, based on a total weight of the metallocene solution; and
a molar ratio of aluminum of the TMA to a transition metal of the metallocene compound is from 0.5:1 to 100:1.

4. The metallocene solution of claim 3, wherein the C₄-C₈ alkane solvent comprises heptane.

5. The metallocene solution of claim 1, wherein the metallocene compound comprises a bridged zirconium or hafnium based metallocene compound with a cyclopentadienyl group and a fluorenyl group.

6. The metallocene solution of claim 1, wherein the metallocene compound comprises an unbridged zirconium based metallocene compound containing a cyclopentadienyl group and an indenyl group.

7. The metallocene solution of claim 1, wherein the metallocene compound comprises:
(η⁵-1-butylcyclopentadenyl)(η⁵-1-propen-2-yl-indenyl) zirconium dichloride;
diphenylmethylidene(η⁵-(3-penten-4-yl)cyclopentadiene-1-yl)(η⁵-2,7-di-tert-butylfluoren-9-ylidene) hafnium dichloride;
methyl(buten-3-yl)methylidene(η⁵-cyclopentadienyl)(η⁵-2,7-di-tert-butylfluoren-9-ylidene) zirconium dichloride;
rac-1,2-ethylenebis(η⁵-1-indenyl) zirconium dichloride;
rac-dimethylsilylbis(η⁵-1-indenyl) zirconium dichloride;
diphenylmethylidene(η⁵-(3-penten-4-yl)cyclopentadiene-1-yl)(η⁵-2,7-di-tert-butylfluoren-9-ylidene) zirconium dichloride;
diethylmethylidene(η⁵-cyclopentadienyl)(η⁵-3-n-propylinden-1-yl) zirconium dichloride;
bis(η⁵-indenyl) zirconium dichloride;
bis(η⁵-n-butylcyclopentadienyl) zirconium dichloride; or
any combination thereof.

8. The metallocene solution of claim 1, wherein the metallocene solution is stable at room temperature for at least 7 days.

9. A catalyst composition comprising:
(i) a metallocene solution comprising:
trimethylaluminum (TMA);
a C₄-C₈ alkane solvent; and
a metallocene compound in an amount from 0.2 to 8 mg per mL of the metallocene solution;
(ii) an activator-support; and
(iii) an organoaluminum compound.

10. The composition of claim 9, wherein the activator-support comprises a fluorided solid oxide, a sulfated solid oxide, a phosphated solid oxide, or a combination thereof.

11. The composition of claim 9, wherein the activator-support comprises fluorided silica-alumina, fluorided silica-coated alumina, sulfated alumina, or any combination thereof.

12. The composition of claim 9, wherein the organoaluminum compound comprises trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof.

13. The composition of claim 9, wherein:
a weight ratio of the metallocene compound to the activator-support is from 1:1 to 1:100,000;
a weight ratio of the activator-support to the organoaluminum compound is from 100:1 to 1:100;
a molar ratio of the TMA to the organoaluminum compound is from 1:1 to 1:1000; or
any combination thereof.

14. The composition of claim 9, wherein the metallocene compound comprises:
a bridged zirconium or hafnium based metallocene compound with a cyclopentadienyl group and a fluorenyl group; and/or
an unbridged zirconium based metallocene compound containing a cyclopentadienyl group and an indenyl group.

15. The composition of claim 9, wherein:
the amount of the metallocene compound is from 0.75 to 3 mg per mL of the metallocene solution;
the metallocene solution contains from 0.1 to 0.7 wt. % of the metallocene compound, based on a total weight of the metallocene solution;
a molar ratio of aluminum of the TMA to a transition metal of the metallocene compound is from 1:1 to 15:1; or
any combination thereof.

16. The composition of claim 9, wherein the catalyst composition is substantially free of aluminoxane compounds, organoboron or organoborate compounds, ionizing ionic compounds, or combinations thereof.

17. A polymerization process comprising contacting the catalyst composition of claim 9 with ethylene and an optional olefin comonomer in a polymerization reactor system under polymerization conditions to produce an ethylene polymer.

18. The polymerization process of claim 17, wherein the catalyst composition is contacted with ethylene and the olefin comonomer comprising a C₃-C₁₀ alpha-olefin.

19. The polymerization process of claim 17, wherein the polymerization reactor system comprises a slurry reactor, a gas-phase reactor, a solution reactor, or a combination thereof.

20. The polymerization process of claim 17, wherein the ethylene polymer comprises an ethylene homopolymer, an ethylene/1-butene copolymer, an ethylene/1-hexene copolymer, an ethylene/1-octene copolymer, or any combination thereof.
